(19) United States
(12) Patent Application Publication
(10) Pub. No.: US 2023/0311141 A1
(43) Pub. Date: Oct. 5, 2023

(54) VALVE ARRANGEMENT

(71) Applicant: Focke & Co. (GmbH & Co. KG), Verden (DE)

(72) Inventors: Jan-Christian Walter, Bardowick (DE); Dennis Bolten, Norderstedt (DE)

(73) Assignee: Focke & Co. (GmbH & Co. KG), Verden (DE)

(21) Appl. No.: 18/005,763

(22) PCT Filed: Jul. 21, 2021
(86) PCT No.: PCT/EP2021/069362

§ 371 Date: Jan. 17, 2023

(30) Foreign Application Priority Data
Jul. 27, 2020 (DE) 10 2020 119 763.2

(51) Int. Cl. B05B 7/16; B05B 1/30; B05B 13/02; B05B 7/10; B05C 5/00

(52) U.S. Cl. CPC B05B 7/1626; B05B 1/3053; B05C 5/001; B05B 7/10; B05B 13/02

(57) ABSTRACT

A valve arrangement for applying flowable medium to a substrate, in particular hotmelt adhesive, which valve arrangement has a distribution element and a heating device, the heating device being arranged outside the distribution element and being fastened, preferably detachably, as a unit to the distribution element.

### CROSS REFERENCE TO RELATED APPLICATIONS

This application is the US national phase of and claims the benefit of and priority on International Application No. PCT/EP2021/069362 having an international filing date of 12 Jul. 2021, which claims priority on and the benefit of German Patent Application No. 10 2020 119 763.2 having a filing date of 27 Jul. 2020.

### BACKGROUND OF THE INVENTION

### Technical Field

The present invention relates to a valve arrangement for applying flowable medium to a substrate, which valve arrangement has a distribution element, to which the medium can be supplied via a medium inlet, wherein the distribution element has medium outlets, which are fluidically connected to the medium inlet, and wherein a spray valve device, which is arranged on the distribution element and has a nozzle for output of the flowable medium, is connected to each medium outlet, to which spray valve device the flowable medium is supplied via the medium outlet. In this arrangement, the distribution element has air outlets which are fluidically connected to a compressed air inlet of the valve arrangement and are each connected to one of the spray valve devices, in particular to the nozzle of the respective spray valve device, and via which heated compressed air which acts on the medium is in each case supplied to the spray valve devices. Such a valve arrangement furthermore has, upstream of the air outlets, one or more heating elements for heating compressed air, wherein the or each heating element is associated with a portion or in each case one portion, in particular is positioned in the or the respective portion, of a compressed air channel fluidically connected on the one hand to the air outlet of at least one spray valve device connected to said portion and on the other hand to the compressed air inlet of the valve arrangement, and compressed air flowing through the respective portion is guided past the heating element—in particular parallel to the longitudinal extent thereof—in order to transfer heat of the heating element to the compressed air.

### Prior Art

When such valve arrangements are used for the application of hotmelt adhesive, the temperature of the compressed air used is usually adapted to the temperature of the hotmelt adhesive during operation and is kept at a substantially constant temperature value by means of feedback control. For this purpose, the current compressed air temperature must be determined as accurately as possible in each case. The applicant has recognized that this detection is often inaccurate in the case of the known valve arrangements. This is due, inter alia, to the fact that, in the vast majority of systems, the respective temperature measuring sensor not only measures the temperature of the compressed air but is also unintentionally influenced to a large extent by the heat/temperature of the distribution element, which is heated during operation by the flow of the hotmelt adhesive.

### BRIEF SUMMARY OF THE INVENTION

Proceeding from this, it is the object of the present invention to further develop a valve arrangement of the type mentioned at the outset, in particular in such a way that it is possible to detect the temperature of the current compressed air temperature as accurately as possible and with as little delay as possible.

This object is achieved by a valve arrangement for applying flowable medium to a substrate, in particular hotmelt adhesive, which valve arrangement has a distribution element, which is, in particular, in one piece, preferably solid or designed as a solid body, to which the medium can be supplied via a medium inlet, wherein the distribution element has medium outlets, which are fluidically connected to the medium inlet, wherein a spray valve device, which is arranged, in particular detachably, on the distribution element and has a nozzle, in particular a spray nozzle, for output of the flowable medium, is connected to each medium outlet, to which spray valve device the flowable medium is supplied via the medium outlet, wherein the distribution element has air outlets, which are fluidically connected to a compressed air inlet of the valve arrangement and which are each connected to one of the spray valve devices, in particular to the nozzle of the respective spray valve device, and via which heated compressed air which acts on the medium is supplied to the spray valve devices, wherein the valve arrangement has a heating device which, upstream of the air outlets, has one or more, in particular elongate, heating elements for heating compressed air, wherein the or each heating element is associated with a portion or in each case one portion, in particular is positioned in the or the respective portion, of a compressed air channel fluidically connected on the one hand to the air outlet of at least one spray valve device connected to said portion and on the other hand to the compressed air inlet of the valve arrangement, wherein compressed air flowing through the or through the respective portion is guided past the or each heating element—in particular parallel to the longitudinal extent thereof—in order to transfer heat of the heating element to the compressed air, characterized in that the heating device is arranged outside the distribution element and is fastened, preferably detachably, as a unit to the distribution element, in particular in a manner involving thermal decoupling of the heating device and the distribution element.

This object is further achieved by a valve arrangement having for applying flowable medium to a substrate, in particular hotmelt adhesive, which valve arrangement has a distribution element, which is, in particular, in one piece, preferably solid or designed as a solid body, to which the medium can be supplied via a medium inlet, wherein the distribution element has medium outlets, which are fluidically connected to the medium inlet, wherein a spray valve device, which is arranged, in particular detachably, on the distribution element and has a nozzle, in particular a spray nozzle, for output of the flowable medium, is connected to each medium outlet, to which spray valve device the flowable medium is supplied via the medium outlet, wherein the distribution element has air outlets, which are fluidically connected to a compressed air inlet of the valve arrangement and which are each connected to one of the spray valve devices, in particular to the nozzle of the respective spray valve device, and via which heated compressed air which acts on the medium is in each case supplied to the spray valve devices, wherein the valve arrangement has a heating device which, upstream of the air outlets, has at least two elongate, spaced-apart, in particular parallel-aligned heating elements for heating compressed air, which are each associated with a portion, in particular are positioned in this portion, of a compressed air channel fluidically connected on the one hand to the air outlet of at least one spray valve device connected to said portion and on the other hand to the compressed air inlet of the valve arrangement, and past which compressed air flowing through the respective portion is guided—in particular parallel to the longitudinal extent thereof—in order in each case to transfer heat of the heating element to the compressed air, characterized in that, downstream of these portions, the heating device has a further portion of the compressed air channel, which is positioned, in particular centrally, between the heating elements preferably with in each case substantially the same spacing from the heating elements, in particular in such a way as to extend parallel to the heating elements and/or to the portions of the compressed air channel which are associated with the heating elements, in which portion a measuring portion of a temperature measuring sensor is arranged in order to measure the compressed air temperature.

According to the invention, it is accordingly envisaged, on the one hand, that the heating device of the valve arrangement mentioned at the outset is arranged outside the distribution element (which is, in particular, solid or designed as a solid body) and is fastened, preferably detachably, as a unit to the distribution element, in particular in a manner involving thermal decoupling of the heating device and the distribution element. According to the invention, in contrast to most solutions in the prior art, the heating device and thus the heating element(s) are accordingly not arranged in the distribution element. Correspondingly, a temperature measuring sensor for measuring the compressed air temperature can also be arranged outside the distribution element, namely can be associated directly with the heating device, which is separate in this respect, and therefore the temperature measuring sensor would accordingly not be influenced, or would be influenced only insignificantly, by any heating of the distributor block.

On the other hand, according to the invention, it is additionally or alternatively correspondingly envisaged that the heating device has at least two heating elements, which, upstream of the air outlets, have at least two elongate, spaced-apart, in particular parallel-aligned heating elements for heating compressed air, which are then each associated with a portion, in particular are each positioned in this portion, of a compressed air channel fluidically connected on the one hand to the air outlet of at least one spray valve device connected to said portion and on the other hand to the compressed air inlet of the valve arrangement, and past which compressed air flowing through the respective portion is guided—in particular parallel to the longitudinal extent thereof—in order in each case to transfer heat of the respective heating element to the compressed air, wherein, downstream of these portions, the heating device has a further portion of the compressed air channel, which is positioned between the heating elements and in which a measuring portion of a temperature measuring sensor is arranged in order to measure the compressed air temperature.

This arrangement of the measuring portion of the temperature measuring sensor within a portion of the compressed air channel and, in addition, precisely in a portion which is arranged, in particular centrally, between the two (or, if appropriate, further) heating elements or between the portions of the compressed air channel which are associated with said heating elements, ensures an optimum heat flow from the heating elements to the temperature measuring sensor and thus ensures low measuring inertia; specifically, even if the air in the compressed air channel is currently not moving or is “standing still” and, to this extent, the air in the further portion has not been guided past the heating elements directly beforehand.

Preferably, the further portion of the compressed air channel, in which the measuring portion of the temperature measuring sensor is arranged, can in each case have substantially the same spacing from the or all of the heating elements in order to this extent to bring about a uniform or “symmetrical” influence on the temperature by both heating elements at the measuring location.

As a further preference, the further portion of the compressed air channel can extend parallel to the heating elements and/or to the portions of the compressed air channel which are associated with the heating elements.

In particular, the further portion of the compressed air channel, in which the measuring portion of the temperature measuring sensor is arranged, can be positioned between two parallel, preferably horizontal, planes, in which in each case the heating elements and/or in each case the portions of the compressed air channel associated with these are arranged.

The measuring portion of the temperature measuring sensor can be aligned in each case parallel to the two heating elements and/or in each case to the portions of the compressed air channel associated with these.

As regards the portions of the compressed air channel associated with the heating elements, these can preferably be connected in parallel in terms of flow, ensuring that compressed air is guided in parallel to the two heating elements from a or the compressed air source to which the valve arrangement is connected during operation.

According to a further important development of the invention, in particular for the parallel connection of these portions of the compressed air channel, the portions of the compressed air channel which are associated with the heating elements can be fluidically connected to one another via at least one portion—connecting portion—of the compressed air channel which runs transversely to them, in particular is arranged in a common plane.

As a preferred option, the portions of the compressed air channel which are associated with the heating elements can be fluidically connected to one another via two such connecting portions, which run transversely and are preferably each arranged in one of two mutually spaced planes. In particular via a first connecting portion, which runs partially in the region of a respective first heated end of a heating cartridge of the respective heating element, and via a second connecting portion, which is arranged downstream of the first connecting portion and which runs partially in the region of a respective second heated end, which is spaced apart from the first heated end, of the heating cartridge of the respective heating element.

In particular, the further portion of the compressed air channel can then additionally be fluidically connected to at least one of these connecting portions (theoretically, however, also to both connecting portions). For example, in that an outlet of the connecting portion is connected to the further portion or opens to it. In this case, compressed air to be heated can be guided parallel to the heating elements, heated by them and fed via this connecting portion to the further portion, in which the measuring portion of the temperature measuring sensor is seated.

As a preferred option, it is furthermore possible for an outlet to be arranged in the further portion of the compressed air channel, said outlet being positioned, in particular, adjacent to the measuring portion, from which outlet the heated compressed air is then guided downstream in the direction of the air outlet of the distribution element, that is to say toward the respective spray valve device.

As regards the or each heating element, it can comprise a or in each case one (in particular hollow-cylindrical) heating cylinder having compressed air guiding channels, which are arranged in a manner distributed around the circumference and, in particular, are formed by (longitudinal) slots in the outer wall of the heating cylinder, in which cylinder a preferably cylindrical heating cartridge of the heating element, which cartridge heats the heating cylinder, is seated, in particular centrally.

Here, the opposite ends of the or the respective heating cartridge can preferably be unheated.

The compressed air guiding channels can outwardly or laterally cover a heated zone of the heating cartridge of the or of the respective heating element, which zone is arranged, in particular, between the unheated ends.

Here, provision can be made for the compressed air guiding channels of the heating cylinder not to extend into or not to be arranged in the regions of the heating cylinder which respectively outwardly or laterally cover the unheated ends of the cylindrical heating cartridge.

As regards the heating device as such, it can have a main body, which is, in particular, in one piece, preferably solid or designed as a solid body, in which at least the aforementioned portions of the compressed air channel, the heating element or elements and the measuring portion of the temperature measuring sensor are arranged.

In this case, the or each portion of the compressed air channel can be formed by a or a respective bore in the main body of the heating device.

The heating cylinder of the or of each heating element can preferably be pressed into the portion of the compressed air channel which is associated with the heating element and is formed by the or the respective bore, in particular in a manner which involves the formation of a longitudinal or transverse press fit with the main body of the heating device. This is not least in order to optimize the heat transfer between the main body and the respective heating element.

For the thermal decoupling of the heating device and the distribution element, the heating device can be fastened, in particular detachably, to a receptacle of the distribution element, connected to the distribution element, for the heating device. In particular using a (preferably only one) fastening screw which penetrates a bore in the main body of the heating device and is screwed into the receptacle for the heating device, wherein the receptacle for the heating device consists of a material which has a thermal conductivity which is lower, in particular at least 50% lower, than that of the material of the main body of the heating device and/or of the distribution element.

In this case, the receptacle for the heating device can be fastened to the distribution element using one or more thermally decoupling insulating disks.

The heating device can furthermore have a protective housing, which is thermally decoupled from the main body and is fastened to the main body, preferably screwed thereto using one or more thermally decoupling insulating disks, and covers the main body with respect to the environment, in particular in that the main body is arranged in the protective housing.

Here, the protective housing can consist of a material which has a thermal conductivity which is lower, in particular at least 50% lower, than that of the material of the main body of the heating device and/or of the distribution element.

Further features of the present invention will be found in the appended patent claims, the following description of a preferred exemplary embodiment of the invention and the appended drawings.

### BRIEF DESCRIPTION OF THE DRAWINGS

In the drawings:

FIG. 1 shows an oblique view of a valve arrangement according to the invention;

FIG. 2 shows the valve arrangement from FIG. 1 from viewing direction II in FIG. 1;

FIG. 3 shows a section along section line III-III in FIG. 2;

FIG. 4 shows a section through the valve arrangement along section line IV-IV in FIG. 2;

FIG. 5 shows a section along section line V-V in FIG. 2;

FIG. 6 shows a section along section line VI-VI in FIG. 2;

FIG. 7 shows a section along section line VII-VII in FIG. 6;

FIG. 8 shows a diagram which qualitatively shows the relationships between the operating state, temperature and volume flow in the temperature control of a prior-art valve arrangement; and

FIG. 9 shows a diagram analogous to FIG. 8, but related to a valve arrangement according to the present invention.

### DETAILED DESCRIPTION OF PREFERRED EMBODIMENTS

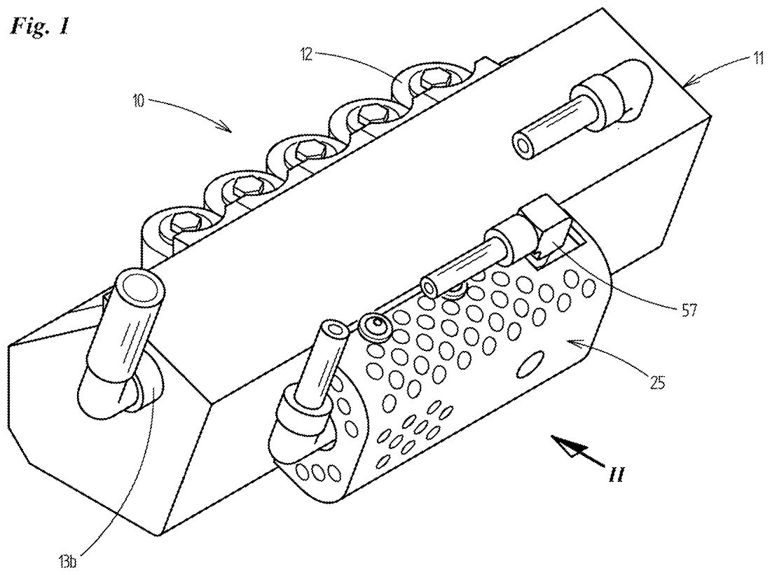

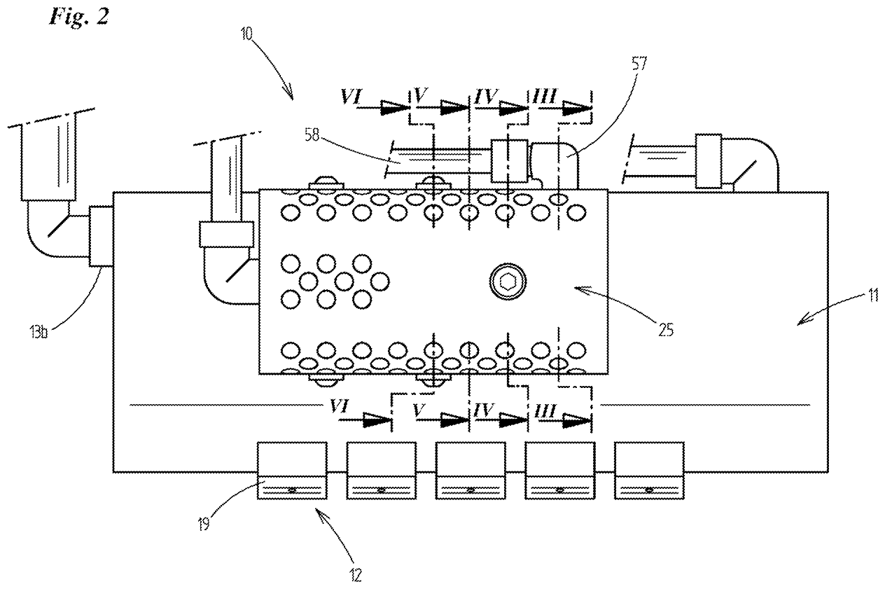

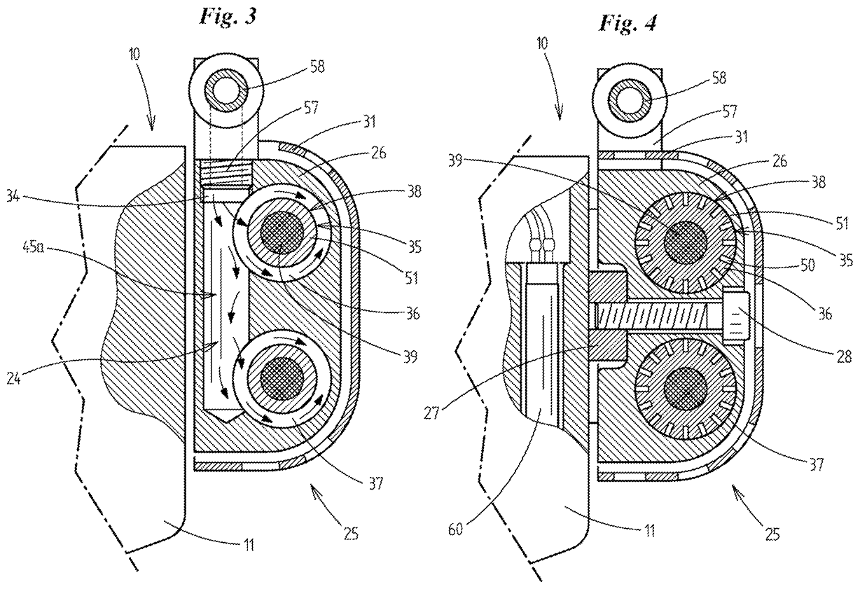

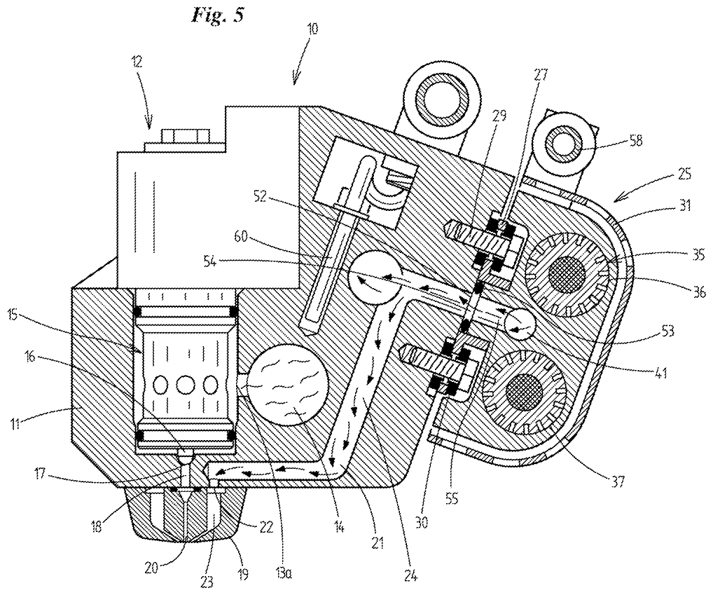

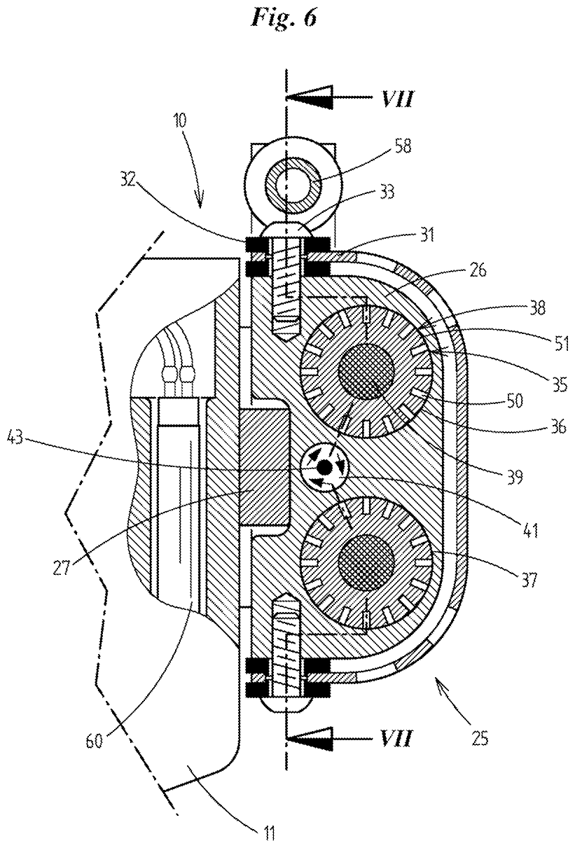

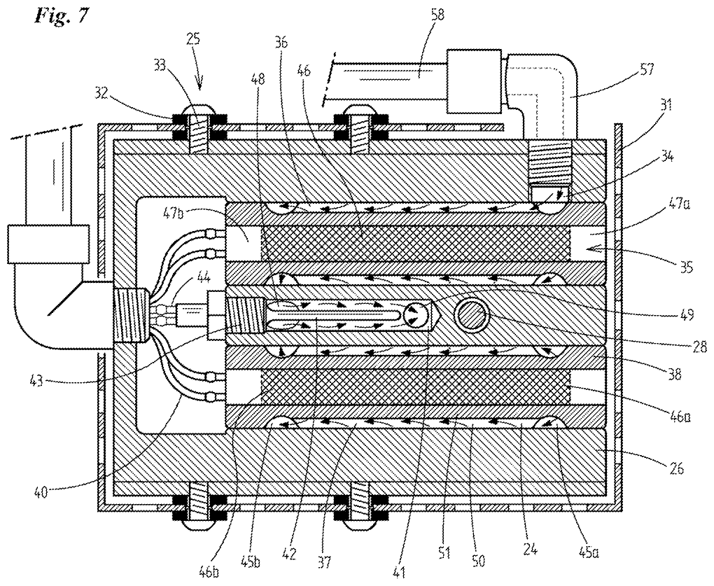

The valve arrangement 10 shown in FIG. 1 is used for applying hotmelt adhesive to substrates of any kind, such as blanks or film webs, which are used in the production of cigarette packs. However, the invention is not restricted to such a use. The valve arrangements according to the invention can also be used for applying other types of flowable media to other substrates.

The valve arrangement 10 has a one-piece, solid distribution element 11 designed as a solid body, which serves for distributing liquid medium supplied from the distribution element 11 to, in the present case, five spray valve devices 12, which are (detachably) fastened to the distribution element 11 and by which the liquid medium is applied to the substrate in each case.

In this case, the spray valve devices 12 are each connected via an associated medium outlet 13a of the distribution element 11 to a medium channel 14 arranged in the distribution element 11. In this case, the liquid medium, that is to say in the present case the hotmelt adhesive, is supplied to the medium channel 14 via a medium inlet 13b of the distribution element 11, which is connected to a medium source or a medium reservoir (not illustrated). One or more heating elements 60, which are arranged in the distribution element 11, provide a heat supply to the medium in order to keep it at a certain temperature and/or to heat it to such a temperature.

Specifically, the liquid medium is supplied to a spray valve unit 15 of the spray valve device 12, which in a manner known per se has a, for example, electromagnetically operated valve with a metering element 16, which either opens or closes a valve opening 17 of the spray valve unit 15.

The valve opening 17 is fluidically connected to a spray nozzle 19 of the spray valve device 12 by a metering channel 18 arranged in the distribution element 11. During operation of the valve arrangement 10, the medium is correspondingly supplied to the spray nozzle 19 and emerges from the spray nozzle 19 at the end of a discharge channel 20.

In a manner known per se, the exiting (liquid) medium is intentionally swirled by the supply of previously heated compressed air in order to produce specific medium application patterns on the substrate.

The heated compressed air is supplied to the spray valve device 12, in the present case to the spray nozzle 19 thereof, via a portion 21 of a compressed air channel 24 which is fluidically connected to an air outlet 22 which is arranged in the distribution element 11 and opens into an, in the present case, annular discharge channel 23 of the spray nozzle 19.

The compressed air channel 24 also has further portions in the distribution element 11, which in each case lead to the other spray valve devices 12 or to the spray nozzles 19 thereof.

The compressed air is supplied to the compressed air channel 24 or valve arrangement 10 from a compressed air source (not illustrated). Before it reaches the spray nozzle 19, however, it is heated in a heating device 25, the temperature of the compressed air being matched to the temperature of the (liquid) application medium, that is to say in the present case to the temperature of the hotmelt adhesive. It is important here to regulate the heating of the compressed air in the most precise and dynamic manner possible to a preset temperature value. This is accomplished by means of a feedback control device (not illustrated).

The more accurate and inertia-free the aforementioned matching or regulation, the more accurate the application pattern of the medium on the substrate becomes during the operating time of the valve arrangement 10.

For this purpose, it is necessary to measure the temperature of the heated compressed air as precisely as possible and with as little delay as possible. In order to achieve this, the valve arrangement 10, in particular the heating device 25 thereof, is designed in a special way.

On the one hand, the heating device 25 is designed as a unit which is separate from the distribution element 11 and arranged outside the distribution element 11 and is fastened, in the present case detachably, to the distribution element 11. In the present case with thermal decoupling of the heating device 25, on the one hand, and the distribution element 11, on the other hand.

Specifically, the heating device 25 has, in a manner which will be described in more detail below, a main body 26 which is in one piece, solid or designed as a solid body and is fastened (detachably) to the distribution element 11 in a thermally decoupled manner.

In this case, the distribution element 11 has a receptacle 27, to which the main body 26 is screwed by means of (just) one screw 28.

The receptacle 27 itself is fastened to the distribution element 11 by means of a plurality of screws 29, likewise in a thermally decoupled manner.

In the present case, by using insulating disks 30 which serve as shims or washers.

Both the receptacle 27 and the insulating disks 30 consist of a material, in particular a plastics material, which has a thermal conductivity that is preferably at least 50% lower than the, in particular metallic, material of the main body 26 of the heating device 25 and/or of the distribution element 11 of the valve arrangement 10.

In a similar way, a protective housing 31 or a protective hood of the heating device 25 is also fastened to the main body 26 in a thermally decoupled manner by means of insulating disks 32 and corresponding screws 33.

In this case, the protective housing 31 is arranged outside the fastening regions at a distance (which promotes insulation) from the main body 26, specifically in such a way that it covers the main body 26 with respect to the environment. This reduces the risk of a user inadvertently touching the main body 26 of the heating device 25, which is generally hot during operation.

On the other hand, as will be described further below, the invention envisages designing the compressed air guidance, the compressed air heating and the temperature measurement in the heating device 25 in a special manner.

For this purpose, the compressed air channel 24 of the valve arrangement 10 is continued upstream of the distribution element 11 in the heating device 25, namely in the main body 26 thereof, as far as a compressed air inlet 34 of the valve arrangement 10, into which a connection piece 57 for a hose line 58 leading to a compressed air source (not shown) opens.

Specifically, this continuation of the compressed air channel 24 is accomplished by fluidically connecting portion 21 of the compressed air channel 24 of the distribution element 11 to an opposite portion 55 of the compressed air channel 24, which runs in the main body 26, using a seal 53, specifically by corresponding fluidic connection of an end-located connection outlet 54 of the main body 26 to an opposite end-located connection outlet 52 of the distribution element 11.

As already mentioned, during operation of the valve arrangement 10, compressed air is first of all supplied for heating to the heating device 25 by means of the aforementioned compressed air source. Subsequently, the compressed air heated by the heating device 25 is then fed to the distribution element 11, namely, as described, to portion 21 of the compressed air channel 24 of the distribution element 11.

To heat the compressed air, elongate heating elements 35, which are arranged in parallel in the main body 26 in the present case and along which the compressed air is guided, are provided.

Specifically, these heating elements 35 are arranged in the main body 26 in two portions 36 and 37 of the compressed air channel 24, which run spaced apart and parallel to one another, in particular in planes which are arranged one above the other and are preferably horizontal.

In the present case, the heating elements 35 each comprise a hollow-cylindrical heating cylinder 38, in the center or core of which in each case a cylindrical heating cartridge 39 is seated in contact with the outer wall 51 of the heating cylinder 38 surrounding said cartridge.

In this case, each (electrically operated) heating cartridge 39 is connected to a power supply (not illustrated) via power cables 40 which are led to the outside from the heating device 25 or main body 26 thereof.

Each heating cartridge 39 has unheated zones at its opposite ends, namely a first unheated zone 47a and a second unheated zone 47b, between which a continuous heated zone 46 is arranged, via which the heat is radiated in each case during operation.

A further portion 41 of the compressed air channel 24, which runs parallel to portions 36, 37 and is fluidically connected to the two portions 36 and 37, is positioned centrally between the two portions 36 and 37 of the compressed air channel 24 which are each associated with the heating elements 35, in each case at the same distance from the two portions 36 and 37.

Arranged in this further portion 41 of the compressed air channel 24 is a front measuring portion 42 of a temperature measuring sensor 43, which in the present case runs parallel to the elongate heating elements 35.

Leading to the temperature measuring sensor 43 are signal lines 44, which are connected to an (external) control/evaluation device in order to evaluate the measurement signals of the temperature measuring sensor. The signal lines 44 are also correspondingly led to the outside from the heating device 25 or main body 26.

The compressed air carried from the compressed air source to the heating device 25 via the compressed air inlet 34 is guided in a special way within the main body 26.

On the one hand, the portions 36 and 37 of the compressed air channel 24 are connected fluidically in parallel via a first connecting portion 45a of the compressed air channel 24, said portion running transversely to portions 36 and 37 of the compressed air channel 24 and connecting them together in the process.

The first connecting portion 45a is in this case arranged at the level of the compressed air inlet 34 or in a plane extending transversely to the portions 36, 37 and furthermore at the level of a respective heated first end 46a of the heated zone 46 of the respective heating cartridge 39, which is adjacent to the compressed air inlet 34 and which is adjoined by the unheated zones 47a in each case.

Furthermore, the further portion 41, in which the measuring portion 42 of the temperature measuring sensor 43 is seated, is fluidically connected, via a second connecting portion 45b running parallel to the first connecting portion 45a, to the portions 36 and 37 of the compressed air channel 24 which are associated with the heating elements 35.

The second connecting portion 45b of the compressed air channel 24 also runs transversely to the two portions 36 and 37. The second connecting portion 45b is arranged at the level of a second heated end 46b of the heated zone 46 of the respective heating cartridge 39, which end is adjoined by the unheated zones 47b of the heating cartridges 39 in each case.

The fluidic connection of the second connecting portion 45b to the further portion 41, in which the measuring portion 42 of the temperature measuring sensor 43 is seated, takes place via an inlet 48, via which, during operation, compressed air flows downstream into the further portion 41, flows around the measuring portion 42 there, is then guided at a different end of the further portion 41 out of an outlet 49 of the further portion 41, downstream in the direction of the portion 55 of the compressed air channel 24 and finally flows into the portion 21 of the compressed air channel 24 which is associated with the distribution element 11.

In the present case, the two portions 36 and 37 as well as the portions 41, 45a, 45b, 55 are, moreover, bores in the main body 26, which is designed as a solid body, or in the main body material.

The heating elements 35 are seated in the bores forming the portions 36 and 37 of the compressed air channel 24; specifically, they are pressed into these bores, for example forming a longitudinal or transverse press fit with the surrounding material of the main body 36.

Specifically, as regards the transfer of the heat of the heating cartridges 39 to the compressed air guided past them, the heating cylinders 38 each have on their circumference for this purpose compressed air guiding channels 50 along which the compressed air is guided to enlarge the contact area between the hot heating cylinder wall 51 and the compressed air.

In the present case, the compressed air guiding channels 50 are formed as longitudinal slots (running parallel to one another) in the outer wall 51 of the respective heating cylinders 38. The air guided through these compressed air guiding channels 50 is correspondingly heated by the heating cylinder material heated by the heating cartridges 39 or is correspondingly heated by the heat emanating from the heating cylinders 39 on its way along the compressed air guiding channels 50.

It is self-evident that the compressed air guiding channels 50 do not have to be designed as slots that run parallel to the longitudinal axis of the heating cylinder. Inter alia, a helix profile along/in the wall 51 or other types and profiles of the compressed air guiding channels 50 is also conceivable.

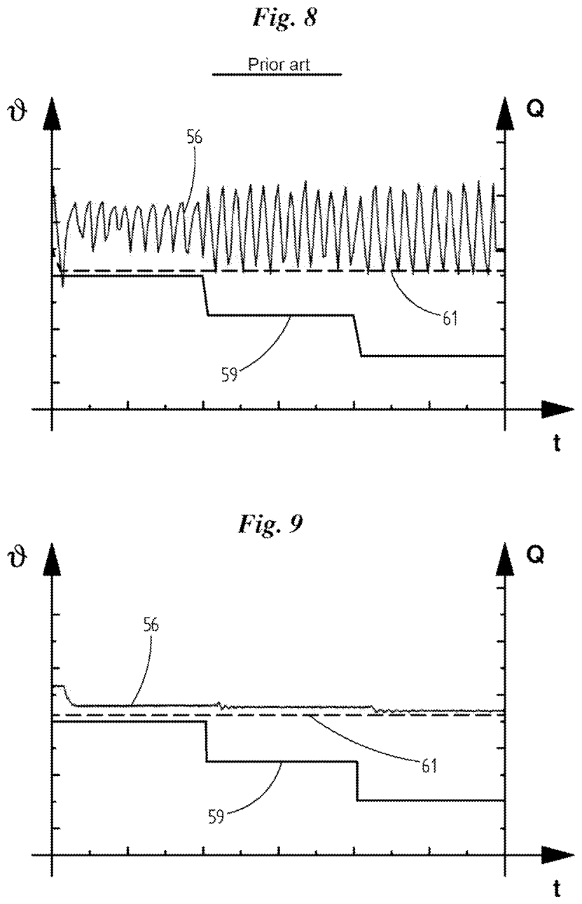

In the diagrams in FIGS. 8 and 9, the temperature 4 and the volume flow Q are plotted against time t (operating time) and, as graphs, the actual and the setpoint temperatures 56 and 61, respectively, of the compressed air and the actual volume flow 59.

The above-described measures according to the invention lead, as illustrated in FIG. 9, to deviations of the actual temperature 56 of the compressed air from a setpoint temperature 61 during operation of the valve arrangement 10 being largely independent of the volume throughput 59 or the volume flow of the compressed air and the selected setpoint temperature 61. It can be seen, in particular, that, in the event of changes in the volume flow 59 of the compressed air, the control system can respond so accurately and dynamically that the actual temperature is subject to only slight fluctuations.

In comparison, FIG. 8 shows, for a prior-art valve arrangement, how the actual temperature 56 is subject to large fluctuations there, particularly in the event of changes in the actual volume flow 59 of the compressed air, but also in the event of an unchanged volume flow 59. As already mentioned, this is due, in particular, to significantly less favorable positioning of the respective temperature measuring sensors, which accordingly cannot provide current or accurate measured temperature values, to less favorable flow guidance of the compressed air in the region of the heating elements, to less favorable design of the heating elements themselves, and to the fact that the prior-art heating devices, in particular the heating elements thereof, are generally arranged within the distribution element 11 and not in a separate main body 26.

### LIST OF REFERENCE SIGNS

10 valve arrangement
11 distribution element
12 spray valve device
13a medium outlet of distribution element
13b medium inlet of distribution element
14 medium channel
15 spray valve unit
16 metering element
17 valve opening
18 metering channel
19 spray nozzle
20 discharge channel
21 compressed air channel portion of distribution element
22 air outlet of distribution element
23 nozzle discharge channel
24 compressed air channel
25 heating device
26 main body
27 receptacle
28 screw for fastening heating device
29 screws for fastening receptacle
30 insulating disks
31 protective housing
32 insulating disks
33 screws for fastening protective housing
34 compressed air inlet
35 heating element
36 portion of compressed air channel for heating element
37 portion of compressed air channel for heating element
38 heating cylinder
39 heating cartridge
40 power cable of heating cartridge
41 further portion for sensor
42 measuring portion
43 temperature measuring sensor
44 signal lines
45a first connecting portion
45b second connecting portion
46 heated zone
46a first heated ends
46b second heated ends
47a first unheated zone
47b second unheated zone
48 inlet of further portion
49 outlet of further portion
50 compressed air channels
51 wall of heating cylinder
52 connection outlet of distribution element
53 seal
54 connection outlet of main body
55 portion of compressed air channel
56 actual temperature
57 connection piece for hose line
58 hose line
59 volume flow
60 heating element for hotmelt adhesive
61 setpoint temperature

1. A valve arrangement for applying flowable medium to a substrate, in particular hotmelt adhesive, which valve arrangement comprises:
a distribution element (11), which is, in particular, in one piece, preferably solid or designed as a solid body, to which the medium can be supplied via a medium inlet, wherein the distribution element (11) has medium outlets, which are fluidically connected to the medium inlet, wherein a spray valve device (12), which is arranged, in particular detachably, on the distribution element (11) and has a nozzle (19), in particular a spray nozzle, for output of the flowable medium, is connected to each medium outlet, to which spray valve device the flowable medium is supplied via the medium outlet, wherein the distribution element (11) has air outlets, which are fluidically connected to a compressed air inlet of the valve arrangement and which are each connected to one of the spray valve devices (12), in particular to the nozzle (19) of the respective spray valve device (12), and via which heated compressed air which acts on the medium is supplied to the spray valve devices (12), and
a heating device (25) which, upstream of the air outlets, has one or more, in particular elongate, heating elements (35) for heating compressed air, wherein the or each heating element (35) is associated with a portion or in each case one portion, in particular is positioned in the or the respective portion, of a compressed air channel (24) fluidically connected on the one hand to the air outlet of at least one spray valve device (12) connected to said portion and on the other hand to the compressed air inlet of the valve arrangement, wherein compressed air flowing through the or through the respective portion is guided past the or each heating element (35), in particular parallel to the longitudinal extent thereof, in order to transfer heat of the heating element (35) to the compressed air,
wherein the heating device (25) is arranged outside the distribution element (11) and is fastened, preferably detachably, as a unit to the distribution element (11), in particular in a manner involving thermal decoupling of the heating device (25) and the distribution element (11).

2. The valve arrangement as claimed in claim 1, wherein the heating device (25) has a main body (26), which is, in particular, in one piece, preferably solid or designed as a solid body, in which the portion of the compressed air channel (24) and the heating element (35) are arranged, and also preferably a measuring portion (42), arranged in a further portion of the compressed air channel (24), of a temperature measuring sensor (43) for measuring the compressed air temperature.

3. The valve arrangement as claimed in claim 1, wherein the heating device (25) has at least two elongate, spaced-apart, in particular parallel-aligned heating elements (35) for heating compressed air, which are each associated with a portion, in particular are each positioned in this portion, of a compressed air channel (24) fluidically connected on the one hand to the air outlet of at least one spray valve device (12) connected to said portion and on the other hand to the compressed air inlet of the valve arrangement, and past which compressed air flowing through the respective portion is guided, in particular parallel to the longitudinal extent thereof, in order in each case to transfer heat of the respective heating element (35) to the compressed air, wherein, downstream of these portions, the heating device (25) has a further portion of the compressed air channel (24), in which a measuring portion of a temperature measuring sensor (43) is arranged in order to measure the compressed air temperature, and wherein the further portion of the compressed air channel (24) is positioned between the heating elements (35), preferably in each case with substantially the same spacing from the heating elements (35), in particular in such a way as to extend parallel to the heating elements (35) and/or to the portions of the compressed air channel (24) which are associated with the heating elements (35).

4. A valve arrangement for applying flowable medium to a substrate, in particular hotmelt adhesive, which valve arrangement comprises:
a distribution element (11), which is, in particular, in one piece, preferably solid or designed as a solid body, to which the medium can be supplied via a medium inlet, wherein the distribution element (11) has medium outlets, which are fluidically connected to the medium inlet, wherein a spray valve device (12), which is arranged, in particular detachably, on the distribution element (11) and has a nozzle (19), in particular a spray nozzle, for output of the flowable medium, is connected to each medium outlet, to which spray valve device the flowable medium is supplied via the medium outlet, wherein the distribution element (11) has air outlets, which are fluidically connected to a compressed air inlet of the valve arrangement and which are each connected to one of the spray valve devices (12), in particular to the nozzle (19) of the respective spray valve device (12), and via which heated compressed air which acts on the medium is in each case supplied to the spray valve devices (12), and
a heating device (25) which, upstream of the air outlets, has at least two elongate, spaced-apart, in particular parallel-aligned heating elements (35) for heating compressed air, which are each associated with a portion, in particular are positioned in this portion, of a compressed air channel (24) fluidically connected on the one hand to the air outlet of at least one spray valve device (12) connected to said portion and on the other hand to the compressed air inlet of the valve arrangement, and past which compressed air flowing through the respective portion is guided, in particular parallel to the longitudinal extent thereof, in order in each case to transfer heat of the heating element (35) to the compressed air,
wherein, downstream of these portions, the heating device (25) has a further portion of the compressed air channel (24), which is positioned, in particular centrally, between the heating elements (35) preferably with in each case substantially the same spacing from the heating elements (35), in particular in such a way as to extend parallel to the heating elements (35) and/or to the portions of the compressed air channel (24) which are associated with the heating elements (35), in which portion a measuring portion (42) of a temperature measuring sensor (43) is arranged in order to measure the compressed air temperature.

5. The valve arrangement as claimed in claim 4, wherein the further portion of the compressed air channel (24), in which the measuring portion (42) of the temperature measuring sensor (43) is arranged, is positioned between two parallel, preferably horizontal, planes, in which in each case the heating elements (35) and/or in each case the portions of the compressed air channel (24) associated with these are arranged.

6. The valve arrangement as claimed in claim 4, wherein the measuring portion (42) of the temperature measuring sensor (43) is aligned in each case parallel to the two heating elements (35) and/or in each case to the portions of the compressed air channel (24) associated with these.

7. The valve arrangement as claimed in claim 4, wherein the portions of the compressed air channel (24) which are associated with the heating elements (35) are connected in parallel in terms of flow.

8. The valve arrangement as claimed in claim 4, wherein the portions of the compressed air channel (24) which are associated with the heating elements (35) are fluidically connected to one another via at least one portion, connecting portion, of the compressed air channel which runs transversely to them, in particular is arranged in one plane.

9. The valve arrangement as claimed in claim 8, wherein the portions of the compressed air channel (24) which are associated with the heating elements (35) are fluidically connected to one another via two such connecting portions, which preferably each run in one of two mutually spaced planes, in particular via a first connecting portion, which runs partially in the region of a respective first heated end of a heating cartridge (39) of the respective heating element (35), and via a second connecting portion, which is arranged downstream of the first connecting portion and which runs partially in the region of a respective second heated end, which is spaced apart from the first heated end, of the heating cartridge (39) of the respective heating element (35).

10. The valve arrangement as claimed in claim 9, wherein the further portion of the compressed air channel (24) is additionally fluidically connected to the connecting portion or portions of the compressed air channel (24).

11. The valve arrangement as claimed in claim 4, further comprising an outlet, which is positioned in particular adjacent to the measuring portion (42) and from which the heated compressed air is guided downstream in the direction of the air outlet, is arranged in the further portion of the compressed air channel (24) in which the measuring portion (42) of the temperature measuring sensor (43) is arranged.

12. The valve arrangement as claimed in claim 4, wherein the or each heating element (35) comprises a or in each case one heating cylinder (38) having compressed air guiding channels (50), which are arranged in a manner distributed around the circumference and, in particular, are formed by longitudinal slots in the outer wall of the heating cylinder (38), in which cylinder a preferably cylindrical heating cartridge (39) of the heating element (35), which cartridge heats the heating cylinder (38), is seated, in particular centrally.

13. The valve assembly as claimed in claim 12, wherein opposite ends of the or of the respective heating cartridge (39) are unheated.

14. The valve arrangement as claimed in claim 12, wherein the compressed air guiding channels (50) outwardly or laterally cover a heated zone of the heating cartridge (39) of the or of the respective heating element (35), which zone is arranged, in particular, between the unheated ends.

15. The valve arrangement as claimed in claim 13, wherein the compressed air guiding channels (50) of the heating cylinder (38) do not extend into or are not arranged in the regions of the heating cylinder (38) which respectively outwardly or laterally cover the unheated ends of the heating cartridge (39).

16. The valve arrangement as claimed in claim 4, wherein the heating device (25), which in particular forms a unit, is fastened, preferably detachably, to the distribution element (11), preferably in a manner involving thermal decoupling of the heating device (25) and the distribution element (11).

17. The valve arrangement as claimed in claim 4, wherein the heating device (25) has a main body (26), which is, in particular, in one piece, preferably solid or designed as a solid body, in which the portions of the compressed air channel (24), the heating element or elements (35) and the measuring portion (42) of the temperature measuring sensor (43) are arranged.

18. The valve arrangement as claimed in claim 17, wherein the or each portion of the compressed air channel (24) is formed by a or a respective bore in the main body (26) of the heating device (25).

19. The valve arrangement as claimed in claim 18, wherein the heating cylinder (38) of the or of each heating element (35) is pressed into the portion of the compressed air channel (24) which is associated with the heating element (35) and is formed by the or the respective bore, in particular in a manner which involves the formation of a longitudinal or transverse press fit with the main body (26) of the heating device (25).

20. The valve arrangement as claimed in claim 4, wherein, for the thermal decoupling of the heating device (25) and the distribution element (11), the heating device (25) is fastened, in particular detachably, to a receptacle (27) of the distribution element (11), connected to the distribution element (11), for the heating device (25), in particular using preferably only a fastening screw which penetrates a bore in the main body (26) of the heating device (25) and is screwed into the receptacle (27) for the heating device (25), wherein the receptacle (27) for the heating device (25) consists of a material which has a thermal conductivity which is lower, in particular at least 50% lower, than that of the material of the main body (26) of the heating device (25) and/or of the distribution element (11).

21. The valve arrangement as claimed in claim 20, wherein the receptacle (27) for the heating device (25) is fastened to the distribution element (11) using one or more thermally decoupling insulating disks.

22. The valve arrangement as claimed in claim 4, wherein the heating device (25) has a protective housing (31), which is thermally decoupled from the main body (26) and is fastened to the main body (26), preferably screwed thereto using one or more thermally decoupling insulating disks, and covers the main body (26) with respect to the environment, in particular in that the main body (26) is arranged in the protective housing (31).

23. The valve arrangement as claimed in claim 22, wherein the protective housing (31) consists of a material which has a thermal conductivity which is lower, in particular at least 50% lower, than that of the material of the main body (26) of the heating device (25) and/or of the distribution element (11).
